(19) United States
(12) Patent Application Publication
(10) Pub. No.: US 2022/0381905 A1
(43) Pub. Date: Dec. 1, 2022

(54) Ultrasonic Navigation System

(71) Applicant: Jonathan Archibold Bondzie, Takoma Park, MD (US)

(72) Inventor: Jonathan Archibold Bondzie, Takoma Park, MD (US)

(21) Appl. No.: 17/747,053

(22) Filed: May 18, 2022

Related U.S. Application Data
(60) Provisional application No. 63/193,332, filed on May 26, 2021.

(51) Int. Cl. G01S 15/66; G01C 21/36; G01S 15/42

(52) U.S. Cl. CPC G01S 15/66; G01C 21/367; G01S 15/42

(57) ABSTRACT

The ultrasonic navigation system uses a root node and extended nodes to transmit and receive ultrasonic signals. The root node is attached to the object to be tracked, i.e., the collar of a pet, a robotic cleaning device, etc. The ultrasonic wave originates from the root node and may include a transmitter; it monitors when it initially sends each signal. The system sends several signal pulses simultaneously so that it can measure distances more effectively. The signals travel from the root node to each extended node (at least three) where they are received, respectively, and each extended node sends a timestamp of when it received the pulse, respectively. These extended nodes are placed around a boundary of a confined area. When the root node emits a signal, it bounces back from all of the extended nodes on the perimeter allowing for continuous and accurate measurement of any space.

### REFERENCE TO RELATED APPLICATIONS

This application claims the benefit of provisional patent application No. 63/193,332 filed May 26, 2021 and titled Ultrasonic Navigation System, which is incorporated in its entirety.

### BACKGROUND OF THE INVENTION

This invention relates generally to navigation systems and, more particularly, to a navigation system that utilizes ultrasonic sound waves to track a moving object within a confined area by quickly and repeatedly sending and receiving ultrasonic sound waves between a root node (e.g., a transmitter) and a plurality of extended nodes (e.g., receivers) so as to continuously triangulate a position of the root node (which is presumably changing, as it is attached to the moving object being tracked). The measurement occurs between the root node and the extended nodes, rather than between the root node and reflections off of objects in the vicinity. In addition, a compass in operative communication with the root node enables the nearly continuous measurements to be translated into a Cartesian grid for presentation of a three-dimensional rendering of the root node's position and movement. In other words, this system is intended to introduce a new type of personal navigation that obtains non-discrete distance measurements by utilizing the speed of sound and how the sonic waves interact with the physical objects.

Traditionally, GPS trackers used by people across the globe are based on a system of satellites in space that bounce radio signals in order to locate the user. This provides roughly 7.8 meters of accuracy, which is a large margin for error especially in smaller confines. Additionally, the typical GPS system also fails to measure in all three dimensions and does not update rapidly enough to be applicable in changing environments. Although presumably effective for their intended purposes, the existing systems still lack accuracy and speed and clarity of presentation when tracking an object whose position is rapidly changing.

Therefore, it would be desirable to have an ultrasonic navigation tracking system that is more applicable and accurate than the typical system that utilizes only radio waves, especially when working in smaller or confined geographic areas. Further, if the environment is either cramped and rapidly changing, it would be desirable to have an ultrasonic navigation system that rapidly and repeatedly updates in three dimensions for the user in order to continue tracking the object in question.

### SUMMARY OF THE INVENTION

The ultrasonic navigation system uses a root node and extended nodes to transmit and receive ultrasonic signals in a manner so as to track an object. The root node is attached to the object to be tracked, i.e., the collar of a pet, a robotic cleaning device, a person walking about a workplace, etc. The root node is where the ultrasonic wave originates and may be signal transmitter; it monitors when it initially sends each signal. It will be understood that each ultrasonic signal may be encoded to include what will be referred to as a “position request” as well as a synch datatype intended to make every position request unique from each other position request. As this is a very accurate method of navigation, the system sends several signal pulses simultaneously, so that it can measure distances more effectively. The signals travel from the root node to each extended node (at least three) where they are received, respectively, and each extended node sends a timestamp of when it received the pulse, respectively. These extended nodes are placed around a boundary of a confined area, such as the property lines in a yard or the confines of a manufacturing plant. When the root node emits a signal, it bounces back from all of the extended nodes on the perimeter, which is what allows for continuous and accurate measurement of any space. In an embodiment, each extended node may be associated with an extended node identifier that is unique from any other extended node identifier such that each one may be identified as is necessary during triangulation as will be described later in more detail.

The root node then acts as a receiver and takes that timestamp and computes how long it took each signal to travel to each node using the equation d=v*t, where d is distance, v is velocity (in this case, the speed of sound), and t is the time elapsed between when the root node sent the signal and the extended node received it. As there are several signals sent out at a given time, the distance measurements are dependent on all of them, which means that the device provides a rapidly updating mapping of the surrounding area. By using the measurements from at least three and, preferably, all of the extended nodes, the root node is able to determine its location relative to the receivers, such as using mathematical triangulation which is known in the art of signal processing. This sending of ultrasonic signals and distance calculations is repeated so rapidly that it is almost continuous. It is understood that the root and extended nodes may be transceivers so as to transmit or receive ultrasonic signals as per their programming or electronic circuitry.

In another aspect, the root node is also operably coupled with a compass that utilizes its position relative to the extended nodes and appropriately transfers the data into a cartesian coordinate system, which allows the navigational measurements to be provided in two, three, or more dimensions which, as a result, provides more accuracy for the user. Moreover, the compass is also able to map other objects within the extended nodes' boundary; this information can be used to generate a sort of map, since that information is also provided in three dimensions.

Therefore, a general object of this invention is to provide an ultrasonic navigation system in which navigational measurements utilize sound waves to calculate distance between a central root node and a plurality of extended nodes in order to provide navigation data indicative of what is between the root and extended nodes.

Another object of this invention is to provide an ultrasonic navigation system, as aforesaid, in which these measurements result from sending several signals simultaneously to gain the most input from the surroundings and then translating the measurements into two or three dimensions.

Still another object of this invention is to provide an ultrasonic navigation system, as aforesaid, in which these measurements are generated quickly and repeatedly so that the system can account for changes in the surrounding environment. For instance, the root node sends out the sound waves and then computes the distances based on the extended nodes' input, so that grid data is continuously updated by the root node.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of an ultrasonic navigation system according to a preferred embodiment of the present system, illustrated with the root node positioned on a pet;

FIG. 2 is a flowchart according to the system as in FIG. 1 that depicts the steps taken to obtain the three-dimensional measurements and the order in which they occur;

FIG. 3a is a block diagram illustrating the electronic components according to the present invention;

FIG. 3b is a block diagram of a position request data type according to the present invention; and

FIG. 3c is a block diagram of an extended node data type according to the present invention.

### DESCRIPTION OF THE PREFERRED EMBODIMENT

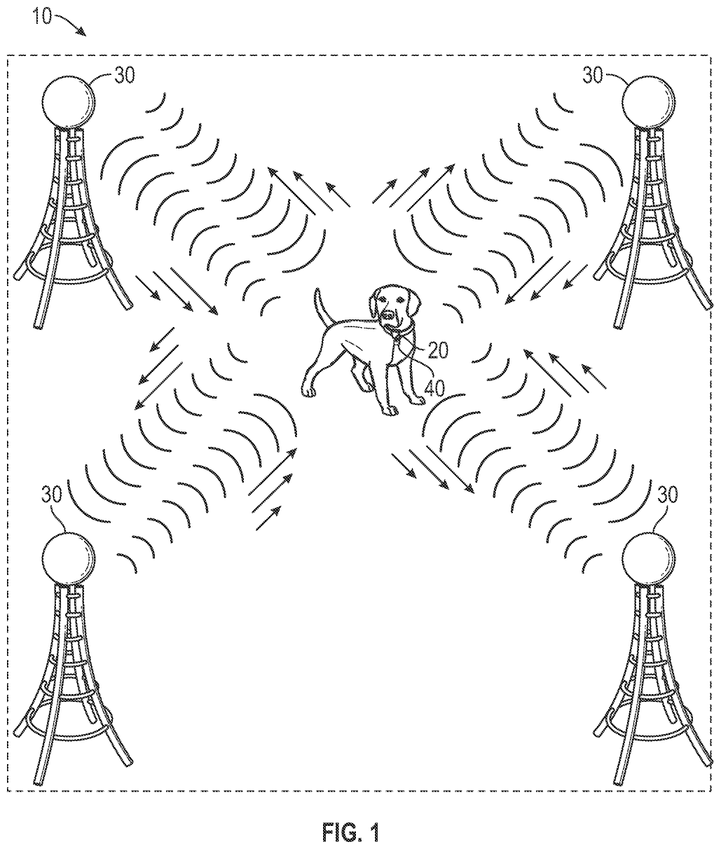

An ultrasonic navigation system according to a preferred embodiment of the present invention will now be described with reference to FIGS. 1 to 3c of the accompanying drawings. The ultrasonic navigation system 10 includes a root node 20, a plurality of extended nodes 30, and a compass 40 in data communication with the root node 20 programmed to translate distance and directional data onto a virtual cartesian grid or map. In addition, the root node 20 may be in data communication with a processor or controller, a memory, and being operable to execute programming steps or may be configured using hard-wired electronics for operating the method steps described below with greater speed and performance.

The basic characteristics of ultrasound/ultrasonic signaling technology is described as follows: Ultrasound is based on sound waves. Higher frequencies lend themselves to higher/better resolution when displayed and are, therefore, preferred in the present application. The speed at which a sound wave travels through a medium is called the propagation speed or velocity. It is equal to the frequency times the wavelength. In ultrasound it is measured in meters per second (m/s) or millimeters per microsecond (mm/μs).

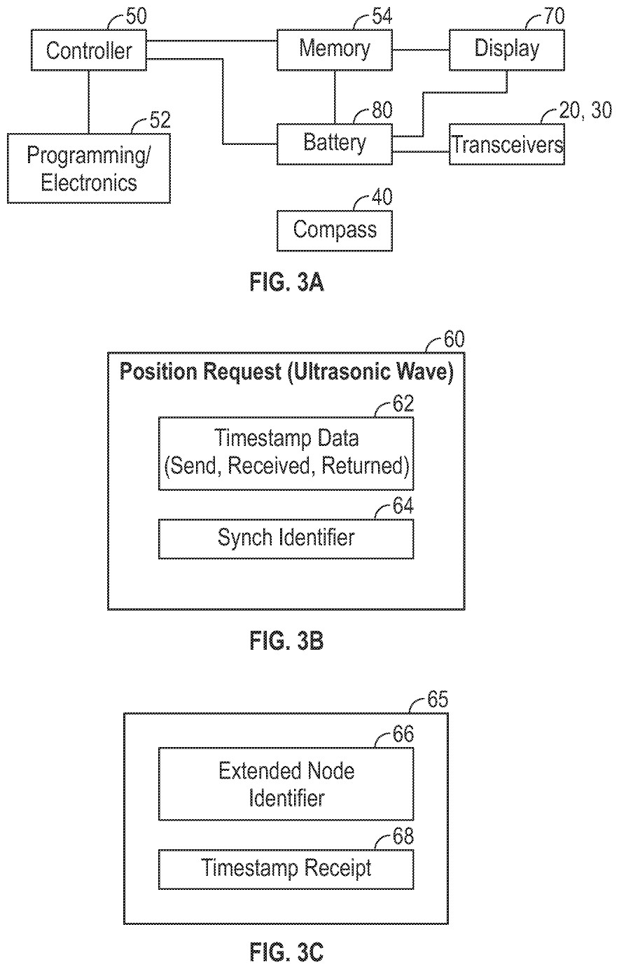

Preferably, the ultrasonic navigation system 10 according to the present invention includes a single root node 20 which may be a transceiver (i.e., an electronic device having both a transmitter and a receiver operable to send and receive ultrasonic signals) placed on a moving object, such as a lawn mower, an employee's clothing, a pet, a guest at a theme park, a robot, or anywhere tracking movement of a moving object on a graphical map is desired. The ultrasonic navigation system 10 also includes at least three extended nodes 30, each of which may also be a transceiver (i.e., an electronic device having both a transmitter and a receiver operable to send and receive ultrasonic signals). Preferably, each extended node is coupled to a tower or other fixed framework defining a perimeter of a space in which a moving object is being tracked or guided. FIG. 1 depicts one root node 20 attached to a pet and three extended nodes are illustrated, it being understood that many more extended nodes 30 may be included in other embodiments. Preferably, there are at least three extended nodes so that time and position data from each may be triangulated to determine a location of the root node 20. A plurality having many extended nodes is preferred. A block diagram illustrating the electronic components of the present system is shown in FIG. 3a. The transceivers and other electronics may be energized by connections to a battery 80. Further, the controller 50 may be programmed or include electronics 52 and programming instructions and timestamp data and the like may be stored in a non-volatile memory 24.

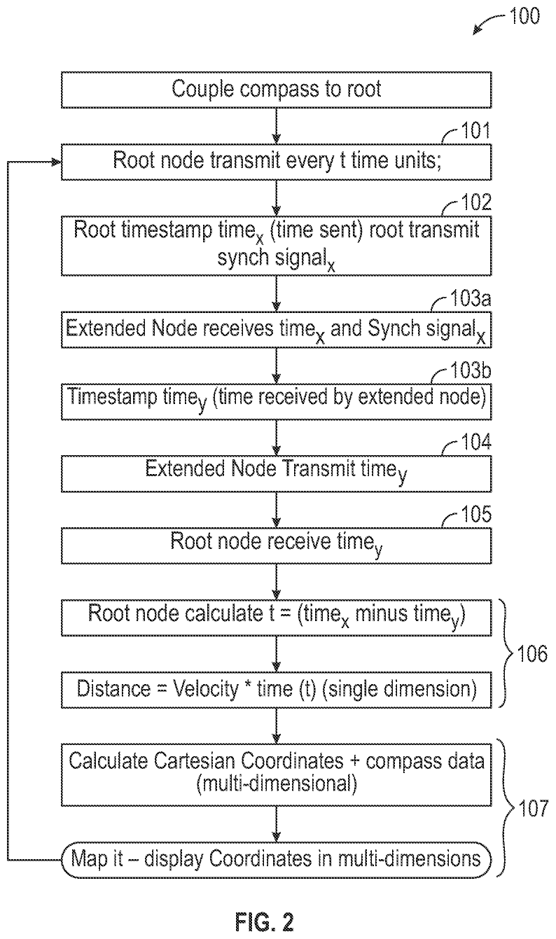

Reference is made to FIG. 2 which represents a method 100 of the present invention shown in the form of a flowchart of method steps. In operation, the root node 20 may be configured or actuated by a controller 50 to transmit ultrasonic waves (signals) at a near-constant or continuous rate (step 101) towards the extended nodes 30. In an embodiment, a predetermined number of ultrasonic waves may be transmitted every second and may be referred to as a transmission frequency. It will be understood that every ultrasonic wave is, essentially, a datatype that will be referred to as a “position request” and represents or is indicative of specific data or information. For instance, a respective ultrasonic wave transmitted by the root node transceiver 20 may include a time step portion and a synch identifier 64 associated therewith (step 102). Then, each time stamped position request 60 is received by a respective extended node transceiver 30 and, in due time, the plurality of extended node transceivers 30. Further, each extended node timestamps when each signal was received (step 103a and 103b) and transmits that information back to the root node 20 (step 104) where it is received (step 105). Referring to FIG. 3c, each extended node 30 may include an extended node datatype 65 having an extended node identifier 66 and a timestamp receipt 68. The extended node identifier 66 may be a number were text that identifies the particular extended node that is generating a timestamp receipt 68 indicative of a time at which a respective position request 60 was received. It will be understood that the ultrasonic wave transmitted by an extended node 30 may be coded or configured to convey this datatype and data stored therein back to the root node 20.

In an important aspect, the root node 20 may continue receiving timestamp receipt data until it has received timestamp receipts from at least three different extended nodes—recalling that each extended node may include an extended node identifier 66 that is unique and different from any other extended node identifier. Accordingly, the root node 20 can determine when sufficient timestamp receipt data has been received and triangulation is possible.

Even more particularly, while the signals are bouncing around, the root node 20 may already be sending new signals to the extended nodes 30, which provide enhanced accuracy to the data. In fact, hundreds or even thousands of tracking waves may be transmitted and received every second, each one being referred to as a position request 60 which may be a data type having a request timestamp portion 62 and a synch identifier portion 64 (FIG. 3b). In other words, each position request 60 may include data indicative of when it was sent, when it was received, and may be uniquely tracked by the logic of a controller 50. It will be understood that the signals transmitted by the root node 20, received, timestamped, transmitted/returned to the root node 20 (step 105) may be coded so as not to be confused with a next signal, then the next signal, and so on.

Stated another way, the coding of signals may be referred to as a synch identifier 64. Such coding may be represented with variables sub-x and sub-y and t in the flowchart of FIG. 2. As will be seen, this rapid-fire signaling in conjunction with compass data will enable tracking of the root node 20 to be converted to Cartesian coordinates in three dimensions (e.g., plotted on an x-y-z grid).

With more particular description of the compass, the data compiled by the root node 20 may then be transferred electrically to a directional compass 40 that is connected to the root node 20. The compass 40 may provide compass data indicative of a current direction of the root node 20 (which is attached to a moving object, such as a pet). In the simplest embodiment, the compass data will be indicative that the root node 20 has moved in a north, south, east, or west direction. In a more complicated embodiment, the compass data may be indicative that the root node 20 has moved in a northwest, north, northeast, southwest, south, southeast, due west, or due east direction. In another embodiment, the compass data may be indicative of even the smallest gradation of movement of the root node 20, such as may be expressed mathematically or graphically on a cartesian plane. As will be seen, the directional data generated by the directional compass 40 may be combined (by the controller) with received transmitted timestamp data for visually mapping movement of the root node 20 (for instance, movement of a pet or other tracked object).

In an embodiment, the controller 50 takes the sent and received timestamps and uses the equation distance=velocity*time (where velocity is the speed of sound) to compute the distance between the root node 20 and each extended node 30 (step 106). Then, the compass 40 takes all of these distance measurements and translates them into a cartesian coordinate system along with a direction component in three dimensions (i.e., or any number of dimensions) in a 3-axis representation (step 107). This three-dimensional data can then be interpreted by nearly any user, given the accessibility of understanding of geometry using three dimensions. The process 100, preferably, loops back to step 101 and the next signal is processed and displayed in real time so as to accurately reflect a position and in directional movement of the root node 20 and the associated object being tracked.

In a critical aspect, the ultrasonic navigation system 10 may include a controller 50 in data communication with a non-volatile memory 54, with the root node transceiver, 20 and the compass 40 described above and may include electronics or programming 52 capable of receiving/storing the time stamped signals described above as well as the compass data indicative of a direction of travel of the root node 20 so as to calculate current position data of the root node 20 based on the signal data and compass data. Further, the ultrasonic navigation system 10 may include a digital display 70 in data communication with the controller 50 on which the results of said calculations may display a mapping thereof as a cartesian plane in three (or more) dimensions (i.e., using three axes). All of the electronics are preferably electrically energized by a battery 80 and may be interconnected via electrical wires or wireless connections as are known in the art.

It is important to note that the “state-of-the-art” in the relative industry of this invention is very sophisticated. Specifically, scalable computing exists that is capable of receiving millions of time stamped data produced by sensors. In an embodiment, the controller 50 may be in data communication with a non-volatile memory 54 and microprocessor for storing large amounts of data that may be generated by the almost constant signaling of the root node 20 and extended nodes 30, intermediate calculations for determining geographic positions and for generating three-dimensional mapping thereof. In fact, managing massive volumes and multiple sources of sensor data is often stored and calculated “in the cloud” which may include quantities of memory and processing power far beyond any traditional or local arena. Further, nontraditional computing resources enable and “Internet of things”, also referred to as IoT, such as the present invention.

By way of clarification, FIG. 2 shows the method 100 of the present invention in a graphical form. The subscript “x” denotes actions by the root node, such as transmission or receipt of signals. The subscript “y” denotes actions by an extended node, such as transmission or receipt of signals. The method 100 of the invention is described in detail above.

It is understood that while certain forms of this invention have been illustrated and described, it is not limited thereto except insofar as such limitations are included in the following claims and allowable functional equivalents thereof.

1. An ultrasonic navigation system for navigating a mobile object in a predetermined space, comprising:
a controller having electronics or programming;
a root node transceiver in data communication with said controller and operable to transmit a plurality of ultrasonic waves indicative of a plurality of position requests when actuated by said controller, each said position request including a request timestamp portion and a synch identifier portion that is uniquely associated with each transmitted position request;
a plurality of extended node transceivers, each extended node transceiver including an extended node identifier and being operable to:
receive said transmitted position request;
assign a timestamp receipt indicative of a time when said transmitted position request was received;
transmit said timestamp receipt and said extended node identifier;
wherein said root node transceiver is operable to receive and to continue receiving said transmitted timestamp receipt and said extended node identifier until respective extended node identifiers associated with at least three different extended node transceivers are received;
a compass in data communication with said root node transceiver and with said controller and is operable to generate direction data indicative of a direction of travel of said root node transceiver;
wherein said controller is in data communication with said compass and is programmed to determine a current position of said root node transceiver relative to said plurality of extended node transceivers by triangulating said received timestamp receipts associated with said at least three different extended node transceivers; and
a display in data communication with said controller operable to display said current geographic position and said direction data in a three-dimensional mapping.

2. The ultrasonic navigation system as in claim 1, wherein said controller is programmed to represent a plurality of transmitted timestamp receipts and said direction data on a mathematical cartesian grid.

3. The ultrasonic navigation system as in claim 1, wherein said controller is programmed to actuate said root node transceiver to transmit a predetermined number of said ultrasonic waves indicative of a plurality of position requests per second.

4. The ultrasonic navigation system as in claim 1, further comprising a non-volatile memory in data communication with said controller, said non-volatile memory being geared for storing programming, time calculations, and mapping coordinates.

5. The ultrasonic navigation system as in claim 1, wherein said controller is programmed to calculate a distance that said root node is separated from a respective extended node by determining a difference between a timestamp associated with when the root node transceiver transmitted a respective position request and a timestamp associated with when said respective extended node receives said respective position request and then multiplying said difference by a velocity associated with an ultrasonic wave.

6. The ultrasonic navigation system as in claim 1, wherein said controller is programmed to determine a current direction of movement of said root node relative to said plurality of extended node transceivers using said transmitted timestamp receipts associated with said plurality of extended node transceivers and said direction data generated by said compass.

7. The ultrasonic navigation system as in claim 6, wherein said root node transceiver is configured to transmit a plurality of said position requests every second, each position request including a synch identifier that is different than any subsequent position request.

8. A method for navigating a mobile object in a predetermined space, comprising:
using a root node transceiver, transmitting a position request via an ultrasonic wave, said position request including a request timestamp portion and a synch identifier portion that is unique to said transmitted position request;
providing a plurality of extended node transceivers each receiving said transmitted position request and assigning a timestamp receipt indicative of when said transmitted position request was received;
transmitting said assigned timestamp receipt and an extended node identifier indicative of which of said plurality of extended node transceivers is associated with said assigned timestamp receipt;
said root node transceiver receiving said assigned timestamp receipt and said extended node identifier until respective extended node identifiers associated with at least three different extended node transceivers are received;
generating direction data using a compass in data communication with said root node transceiver, said generated direction data being indicative of a direction of travel of said root node transceiver;
determining a current geographic position of said root node transceiver relative to said plurality of extended node transceivers by triangulating said assigned timestamp receipts associated with said at least three different extended node transceivers and said direction data; and
displaying said determined current geographic position in a three-dimensional mapping that includes a cartesian grid.

9. The method of navigating as in claim 8, wherein said transmitting a position request includes transmitting a plurality of position requests in succession every second.

10. The method of navigating as in claim 8, further comprising storing time and position data in a non-volatile memory.

11. The method of navigating as in claim 8, further comprising calculating a distance that said root node is separated from a respective extended node by determining a difference between a timestamp associated with when the root node transceiver transmitted a respective position request and a timestamp associated with when said respective extended node received said respective position request and then multiplying said difference by a velocity associated with the ultrasonic wave.

12. The method of navigating as in claim 8, further comprising determining a current direction of movement of said root node relative to said plurality of extended node transceivers using said assigned timestamp receipts and said direction data.
